(19) United States
(12) Patent Application Publication
(10) Pub. No.: US 2020/0281237 A1
(43) Pub. Date: Sep. 10, 2020

(54) COOKING APPLIANCE AND CONTROL METHOD THEREFOR

(71) Applicants: GREE ELECTRIC APPLIANCES (WUHAN) CO., LTD, Wuhan (CN); GREE ELECTRIC APPLIANCES, INC. OF ZHUHAI, Zhuhai (CN)

(72) Inventors: Xiaoxiang Wang, Zhuhai (CN); Jinxi Kong, Zhuhai (CN); Jiang Mei, Zhuhai (CN); Li Song, Zhuhai (CN)

(21) Appl. No.: 16/644,870

(22) PCT Filed: Jun. 1, 2018
(86) PCT No.: PCT/CN2018/089550

§ 371 Date: Mar. 5, 2020

(30) Foreign Application Priority Data
Oct. 10, 2017 (CN) 201710933124.9

(51) Int. Cl. A23L 7/196; A47J 27/00; A47J 27/21

(52) U.S. Cl. CPC A23L 7/1965; A23V 2002/00; A47J 27/21083; A47J 27/004

(57) ABSTRACT

Provided is a cooking appliance and a control method of the cooking appliance. The control method of the cooking appliance is applied to make a claypot rice. The cooking appliance includes a pot body and a heating component for heating raw materials placed in the pot body. A process of making the claypot rice includes a rice stewing stage, and the rice stewing stage at least includes a first rice stewing process and a second rice stewing process which are sequentially executed. The heat output per unit time by the heating component during the first rice stewing process is less than the heat output per unit time during the second rice stewing process.

### TECHNICAL FIELD

The present disclosure relates to the technical field of cooking, in particular to a cooking appliance and a control of a cooking appliance.

### BACKGROUND

Claypot rice, also called soup rice, is a special delicious food of the Han nationality in Guangdong and Guangxi and is cooked by a clay pot. The traditional making process of claypot rice is that: the pre-soaked rice is placed in a clay pot, a proper amount of water is added, and a cover is put on the pot; when rice is cooked to seven maturity at high heat, side dishes are added, and then turn to slow heat to cook the rice thoroughly. Because the process of cooking claypot rice is not done in one go, and it is necessary to add side dishes, a special person is needed to care about; on the other hand, heating the clay pot with a gas stove flame and manually controlling the heat requires a lot of experience. During operation, if the heat is controlled improperly, crispy rice close to the bottom and the side wall of the pot is prone to be overcooked, and it is hard to scrape the crispy rice to eat; besides, the palatability of the crispy rice is poor, as a concrete manifestation, the crispy rice is hard, sticky and not crispy.

In some existing cooking appliances with a claypot rice making function, the control method is usually heating over high heat, and then gradually reducing a heating power until stopping heating. The crispy rice of the claypot rice made by the method has the problem of being sticky and poor in taste.

### SUMMARY

In view of this, one of the objects of the present disclosure is to provide a control method of a cooking appliance which can make the claypot rice with crispy, non-sticky and tasty crispy rice, and the cooking appliance controlled to execute method for control.

To achieve the above object, according to an aspect, the present disclosure adopts the following technical solution.

A control method of a cooking appliance is provided, which is applied to make claypot rice. The cooking appliance includes a pot body and a heating component for heating raw materials placed in the pot body. The process of making the claypot rice includes a rice stewing stage, and the rice stewing stage at least includes a first rice stewing process and a second rice stewing process, which is executed after the first rice stewing process. Heat output per unit time by the heating component during the first rice stewing process is less than heat output per unit time by the heating component during the second rice stewing process.

In some embodiments, after the first rice stewing process is completed, the cooking appliance sends a prompt of performing an operation of separating crispy rice and rice.

In some embodiments, after the first rice stewing process is completed, and in response to a cover closing action detected by the cooking appliance, the second rice stewing process is continued to be executed; or after the first rice stewing process is completed and the cooking appliance receives an instruction of continuing to make the claypot rice, the second rice stewing process is continued to be executed; or after a predetermined time period from a time point of completing the first rice stewing process, the second rice stewing process is continued to be executed.

In some embodiments, the control method includes at least one of the following: during the first rice stewing process, the heating component heats intermittently, so as to maintain the pot body in a first predetermined temperature range;

during the second rice stewing process, the heating component heats intermittently, so as to maintain the pot body in a second predetermined temperature range.

In some embodiments, the control method comprises at least one of the following:

the first predetermined temperature range is 115└ to 135└;

the second predetermined temperature range is 135└ to 155└.

In some embodiments, during the first rice stewing process, the heating component heats intermittently with a first heating duty cycle, or the heating component heats intermittently with a first power; or the heating component heats intermittently with a first heating duty cycle and a first power; during the second rice stewing process, the heating component heats intermittently with a second heating duty cycle, or the heating component heats intermittently with a second power, or the heating component heats intermittently with a second heating duty cycle and a second power.

In some embodiments, the control method includes at least one of the following: the first heating duty cycle is and X₁ is 6 s to 16 s, Y₁ is 16 s to 26 s;
the second heating duty cycle is X₂:Y₂, and X₂ is 16 s to 26 s, and Y₂ is 6 s to 16 s.

In some embodiments, the control method includes at least one of the following:
duration of the first rice stewing process is 10 min to 30 min;
duration of the second rice stewing process is 10 min to 30 min.

In some embodiments, before the rice stewing stage, the process of making the claypot rice further includes a heating stage and a boiling stage;

the heating stage includes a first heating stage and a second heating stage, which is executed after the first heating stage; in the first heating stage, the heating component heats the pot body continuously; in the second heating stage, the heating component heats intermittently with a third heating duty cycle; or,

in the boiling stage, the heating component heats intermittently with a fourth heating duty cycle, so that liquid in the raw materials placed in the cooking appliance maintains a boiling state; or

the heating stage comprises a second heating stage and a first heating stage executed before the second heating stage; in the first heating stage, the heating component heats the pot body continuously; in the second heating stage, the heating component heats intermittently with a third heating duty cycle, and in the boiling stage, the heating component heats intermittently with a fourth heating duty cycle, so that liquid in the raw materials placed in the cooking appliance maintains a boiling state.

In some embodiments, when the cooking appliance starts the process of making the claypot rice, the cooking appliance is controlled to directly enter the heating stage.

In some embodiments, the cooking appliance further includes at least one of the following: a pot body temperature sensor for reflecting a temperature of the pot body, a content temperature sensor for reflecting a temperature of the raw materials placed in the pot body. The cooking appliance switches among the stages according to the temperatures sensed by at least one of the pot body temperature sensor and the content temperature sensor, the stages includes the first heating stage, the second heating stage, a boiling stage and the rice stewing stage.

In some embodiments, in the heating stage, when the temperature of the pot body is greater than or equal to a first preset temperature, the cooking appliance is controlled to switch from the first heating stage to the second heating stage; or,

when the temperature of the pot body is greater than or equal to a second preset temperature, and the temperature of the contents is greater than or equal to a third preset temperature, the cooking appliance is controlled to switch from the second heating stage to the boiling stage; or,

when the temperature of the pot body is greater than or equal to a fourth preset temperature, the cooking appliance is controlled to switch from the boiling stage to the rice strewing stage.

In some embodiments, the control method further includes at least one of the following:

the first preset temperature is 70└ to 90└;

the second preset temperature is 80└ to 100└; the third preset temperature is 60└ to 80└;

the fourth preset temperature is 100└ to 120└.

According to another aspect, the present disclosure adopts the following technical solution.

A cooking appliance is provided, which has a claypot rice mode. In the claypot rice mode, the cooking appliance is controlled to execute the abovementioned control method

In the control method of the cooking appliance provided by the present disclosure, the rice stewing stage of making the claypot rice adopts two rice stewing processes. Low heat output per unit time is used during the first rice stewing process so that the temperature of the pot body is maintained within a low temperature range, thereby forming a layer of crispy rice on the bottom of the pot body and on the wall of the pot body. High heat output per unit time is used during the second rice stewing process so that the temperature of the pot body is maintained within a high temperature range, thereby drying the formed crispy rice at a high temperature, which improves the crispness of the crispy rice and forms a color specific to the crispy rice.

### BRIEF DESCRIPTION OF THE DRAWINGS

By means of the description for the embodiments of the present disclosure with reference to the accompanying drawings, the above and other objects, features and advantages of the present disclosure will become more apparent. In the drawings:

FIG. 1 shows a flowchart of a control method for a rice stewing stage according to a specific embodiment of the present disclosure; and

FIG. 2 shows a flowchart of a control method of the cooking appliance according to a specific embodiment of the present disclosure.

### DETAILED DESCRIPTION OF THE EMBODIMENTS

The present disclosure is described below based on the embodiments, but the present disclosure is not limited to only these embodiments. In the following detailed description of the present disclosure, some specific details are described in detail. The present disclosure is fully understood by those skilled in the art without the description of these details. In order to avoid obscuring the essence of the present disclosure, well-known methods, processes, procedures, and components are not described in detail.

In addition, those of ordinary skill in the art should understand that the drawings are provided for the purpose of illustration, and the drawings are not necessarily to scale.

Unless explicitly required by the context, similar words “include”, “comprise”, and the like in the whole specification and claims should be interpreted as inclusive meanings rather than exclusive or exhaustive meaning, that is, meanings of “including but not limited to”.

In the description of the present disclosure, it is to be understood that the terms “first”, “second” and the like are used for descriptive purposes only and are not to be construed as indicating or implying relative importance. Further, in the description of the present disclosure, the meaning of “multiple” is two or more unless otherwise specified.

Aiming at the problems of the existing cooking appliance with a claypot rice making function that crispy rice is sticky and tastes bad, the applicant finds that the problems are caused by an unreasonable control method of the cooking appliance. Although a heating mode of high heat followed by low heat in the existing control method can avoid blackened crispy rice, because the low heat is adopted in the later making process, the moisture in the crispy rice is not easily dried, the made crispy rice is sticky, which affects the taste.

Aiming at the above problem, the disclosure provides a control method of a cooking appliance. The cooking appliance includes a pot body and a heating component for heating raw materials placed in the pot body. The cooking appliance has a claypot rice making function, and can make non-sticky and tasty claypot rice by controlling the heating component.

Furthermore, the cooking appliance further includes temperature sensors, including a pot body temperature sensor for reflecting a temperature of the pot body and a content temperature sensor for reflecting a temperature of raw materials placed in the pot body. In some embodiments, the pot body includes a main body and a pot cover. The pot body temperature sensor is arranged at the bottom of the main body, and the content temperature sensor is arranged on the pot cover. The temperature sensed by the pot body temperature sensor is defined as T_{B}, and the temperature sensed by the content temperature sensor is defined as T_{T}.

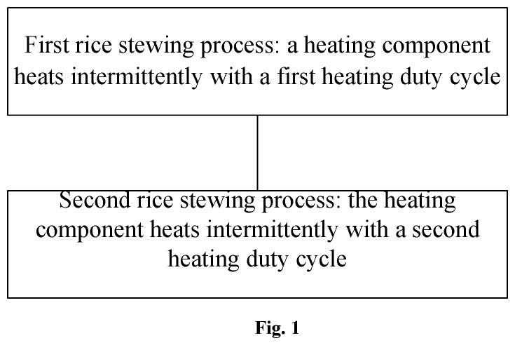

Specifically, the process of making the claypot rice includes a heating stage, a boiling stage, and a stewing stage. The formation of crispy rice is mainly in the stewing stage. In the disclosure, as illustrated in FIG. 1, the stewing stage at least includes a first rice stewing process and a second rice stewing process. The first rice stewing process is executed before the second rice stewing process. It can be understood that just a precedence relationship between the first rice stewing process and the second rice stewing process is limited here, but it is not limited that the second rice stewing process is executed following the first rice stewing process, there may be other operations performed between the two stewing processes. The heat output per unit time by the heating component during the first rice stewing process is less than the heat output per unit time by the heating component during the second rice stewing process, so low heat output per unit time is used during the first rice stewing process so that the temperature of the pot body is maintained within a low temperature range, thereby forming a layer of crispy rice on the bottom of the pot body and on the wall of the pot body. High heat output per unit time is used during the second rice stewing process so that the temperature of the pot body is maintained within a high temperature range, thereby drying the formed crispy rice at a high temperature, which improves the crispness of the crispy rice and forms a color specific to the crispy rice.

The heat output per unit time by the heating component can be adjusted by controlling at least one of a power, a heating duration and a heating duty cycle of the heating component. The definition of the heating duty cycle is a ratio of the time of continuously heating to the time of stopping heating in a loop, the heating component is on and off in loops; for example, if the heating duty cycle is X:Y, then in a loop, the time of continuously heating is X seconds, and the time of stopping heating is Y seconds.

In some embodiments, during the first rice stewing process, the heating component heats intermittently, so as to maintain the pot body in a first predetermined temperature range. The first predetermined temperature range can be set according to a heating mode, capacity and other factors of the cooking appliance. In some embodiments, the first predetermined temperature range is 115└ to 135└, that is, during the first rice stewing process, the temperature of the pot body is maintained in the range of 115└ to 135└ by controlling the heating component. During the second rice stewing process, the heating component heats intermittently, so as to maintain the pot body in a second predetermined temperature range. The second predetermined temperature range can be set according to the heating mode, capacity and other factors of the cooking appliance. In some embodiments, the second predetermined temperature range is 135└ to 155└, that is, during the second rice stewing process, the temperature of the pot body is maintained in the range of 135└ to 155└ by controlling the heating component.

The control of the temperature of the pot body can be realized by setting at least one of a proper heating duty cycle and a proper heating power of the heating component. In some embodiments, during the first rice stewing process, the heating component heats intermittently with a first heating duty cycle; and during the second rice stewing process, the heating component heats intermittently with a second heating duty cycle. The first heating duty cycle is less than the second heating duty cycle. The first heating duty cycle is A range of X₁ is 6 s to 16 s in some embodiments, and a range of Y₁ is 16 s to 26 s in some embodiments. The second heating duty cycle is X₂:Y₂. A range of X₂ is 16 s to 26 s in some embodiments, and a range of Y₂ is 6 s to 16 s in some embodiments. A first heating power of the heating component during the first rice stewing process and a second heating power of the heating component during the second rice stewing process may be equal, may not be equal. When the first heating power and the second heating power are not equal, in some embodiments, the first heating power is lower than the second heating power.

In a specific embodiment, when switching to the first rice stewing process, the cooking appliance first determines a relationship between the current temperature of the pot body and the first predetermined temperature range; if the current temperature of the pot body is higher than the maximum value of the first predetermined temperature range, the heating component does not work, and until the temperature of the pot body decreases to be equal to or lower than the minimum value of the first predetermined temperature range, the heating component starts heating with the first heating duty cycle; or else, the heating component heats directly with the first heating duty cycle. In some embodiments, during the first rice stewing process, when a real-time temperature of the pot body is higher than the maximum value of the first predetermined temperature range, the heating component stops heating, and until the temperature of the pot body decreases to be equal to or lower than the minimum value of the first predetermined temperature range, the heating component heats with the first heating duty cycle again.

Similarly, when switching from the first rice stewing process to the second rice stewing process, the cooking appliance first determines a relationship between the current temperature of the pot body and the second predetermined temperature range; if the current temperature of the pot body is higher than the maximum value of the second predetermined temperature range, the heating component does not work, and until the temperature of the pot body decreases to be equal to or lower than the minimum value of the second predetermined temperature range, the heating component starts heating with the second heating duty cycle; or else, the heating component heats directly with the second heating duty cycle. In some embodiments, during the second rice stewing process, when the real-time temperature of the pot body is higher than the maximum value of the second predetermined temperature range, the heating component stops heating, and until the temperature of the pot body decreases to be equal to or lower than the minimum value of the second predetermined temperature range, the heating component heats with the second heating duty cycle again.

Duration of the first rice stewing process and duration of the second rice stewing process may be determined according to the heating mode, capacity and other factors of the cooking appliance, so as to ensure forming crispy rice during the first rice stewing process and the effect of drying the crispy rice during the second rice stewing process. In some embodiments, the duration of the first rice stewing process is a first predetermined period of time t₁, and the first predetermined period of time t₁ is 10 min to 30 min in some embodiments; and the duration of the second rice stewing process is a second predetermined period of time t₂, and the second predetermined period of time t₂ is 10 min and 30 min in some embodiments. So, in combination with the accurate control of the temperature of the pot body and the accurate control of the heating duration of the pot body, it is ensured that the made claypot rice is not blackened and tastes crispy and non-sticky.

Because sausages, vegetables and other side dishes are often added to rice when claypot rice is made, in some embodiments, in the control method of the disclosure, after the execution of the first rice stewing process is completed, the cooking appliance sends a prompt of performing a separating operation. For example, the prompt may be send by voice or text display. At this point, a user may open the pot cover to stir the rice in the main body, so that the rice in the middle is separated from the crispy rice; at the same time, various side dishes may be added, and then the second rice stewing process is performed. Because the operation of separated the rice and the crispy rice, and there is a gap generating between the crispy rice and the rice, when the crispy rice is dried at a high temperature in the following second rice stewing process, the crispy rice does not absorb or absorbs very little water from the rice, thereby further Improving the crispness of the crispy rice.

The time when the cooking appliance further executes the second rice stewing process may be, for example, after the execution of the first rice stewing process is completed, and in response to a cover closing action detected by the cooking appliance; or after the first rice stewing process is completed and the cooking appliance receives an instruction of continuing to make the claypot rice; or after a predetermined time period from a time point of completing the first rice stewing process, the cooking appliance further executes the second rice stewing process. The predetermined period of time can be set according to specific needs, for example, is set as 3 min to 5 min.

In some embodiments, the heating stage includes a first heating stage and a second heating stage, and the first heating stage is executed before the second heating stage. In some embodiments, the second heating stage is executed directly after the execution of the first heating stage is completed. In the first heating stage, the heating component heats continuously the pot body, so that the temperature of the pot body rises quickly. In the second heating stage, the heating component heats intermittently with a third heating duty cycle, so that the temperature of the pot body further rises. The third heating duty cycle is X₃:Y₃. A range of X₃ is 6 s to 30 s in some embodiments, and a range of Y₃ is 2 s to 26 s in some embodiments.

In some embodiments, in the boiling stage, the heating component heats intermittently with a fourth heating duty cycle, so that liquid in the raw materials placed in the cooking appliance maintains a boiling state, thereby gradually vaporizing the liquid while stewing the rice. The fourth heating duty cycle is X₄:Y₄. A range of X₄ is 10 s to 16 s in some embodiments, and a range of Y₃ is 16 s to 22 s in some embodiments.

Authentic claypot rice requires rice grains to have a good sense of grain, aiming at the problem, in some embodiments, when the cooking appliance starts performing the process of making the claypot rice, the cooking appliance is controlled to directly switch to the heating stage to omit a rice soaking stage, thereby avoiding the effect on the sense of grain after cooking caused by soaking rice for too long, and ensuring that the rice grains are as elastic as they should be. Certainly, it may be understood that in an alternative embodiment, for different users' taste demands, the rice soaking stage may also be performed before the heating stage.

In some embodiments, the cooking appliance switches among the stages (including the first heating stage, the second heating stage, the boiling stage and the rice stewing stage) according to the temperatures sensed by the pot body temperature sensor and the content temperature sensor.

Specifically, in the heating stage, when the temperature of the pot body is greater than or equal to a first preset temperature, the cooking appliance switches from the first heating stage to the second heating stage, the first preset temperature T₁ is 70└ to 90└ in some embodiments; when the temperature of the pot body is greater than or equal to a second preset temperature T₂, and the temperature of the contents is greater than or equal to a third preset temperature T₃, the cooking appliance switches from the second heating stage to the boiling stage, the second preset temperature T₂ is 80└ to 100└ in some embodiments, and the third preset temperature T₃ is 60└ to 80└ in some embodiments; when the temperature of the pot body is greater than or equal to a fourth preset temperature T₄, the cooking appliance switches from the boiling stage to the rice strewing stage, the fourth preset temperature T₄ is 100└ to 120└ in some embodiments.

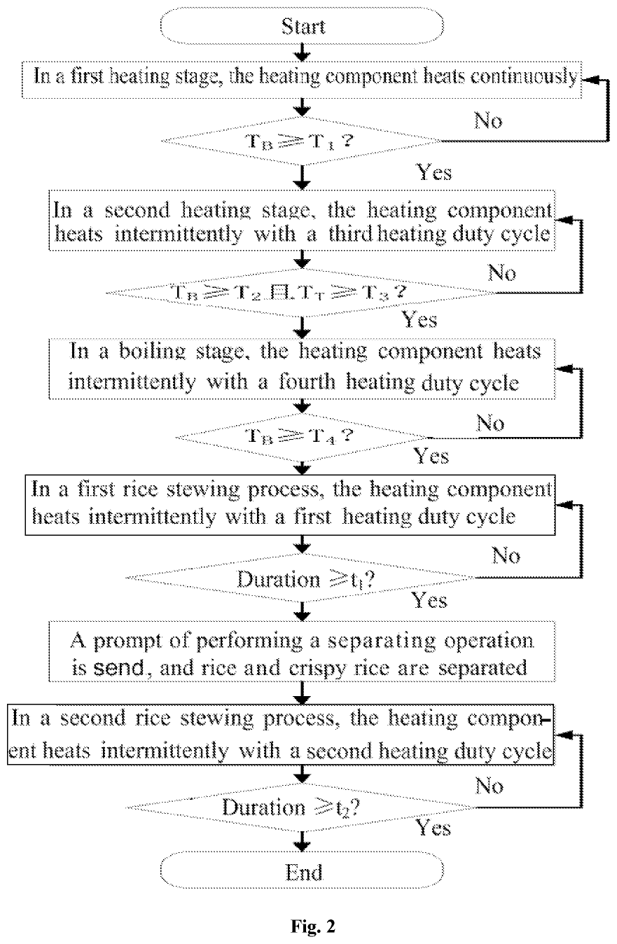

A control process of the cooking appliance making the claypot rice in a specific embodiment of the disclosure is given below. As shown in FIG. 2, the control process includes the following steps.

S001, the process starts.

S002, in the first heating stage, the heating component heats continuously.

S003, it is determined whether T_{B} is greater than or equal to the first preset temperature T₁; if so, S004 is performed; or else, return to the S002.

S004, in the second heating stage, the heating component heats intermittently with the third heating duty cycle.

S005, it is determined whether both T_{B}≥T₂ and T_{T}≥T₃ are satisfied, if so, S006 is performed; or else, return to the S004.

S006, in the boiling stage, the heating component heats intermittently with the fourth heating duty cycle.

S007, it is determined whether T_{B} is greater than or equal to T₄; if so, S008 is performed; or else, return to the S006.

S008, in the first rice stewing process, the heating component heats intermittently with the first heating duty cycle.

S009, it is determined whether the duration of the first rice stewing process is greater than or equal to t₁; if so, S010 is performed; or else, return to the S008.

S010, the prompt of performing the separating operation is send, and the rice and the crispy rice are separated; after that, S011 is performed.

S011, in the second rice stewing process, the heating component heats intermittently with the second heating duty cycle.

S012, it is determined whether the duration of the second rice stewing process is greater than or equal to t₂; if so, S013 is performed; or else, return to the S011.

S013, the stewing process ends.

It will be readily understood by those skilled in the art that the above various preferred solutions can be freely combined and superimposed without conflict.

It will be appreciated that the above embodiments are to be considered as illustrative and not restrictive. Various obvious or equivalent modifications or alterations to the above details will be apparent to those skilled in the art without departing from the basic principle of the present disclosure, which are all included within the scope of the claims of the present disclosure.

What is claimed is:

1. A control method of a cooking appliance, applied to make claypot rice, the cooking appliance comprising a pot body and a heating component for heating raw materials placed in the pot body, wherein a process of making the claypot rice comprises a rice stewing stage, the rice stewing stage at least comprises a first rice stewing process and a second rice stewing process, which is executed after the first rice stewing process, heat output per unit time by the heating component during the first rice stewing process is less than heat output per unit time by the heating component during the second rice stewing process.

2. The control method as claimed in claim 1, wherein after the first rice stewing process is completed, the cooking appliance sends a prompt of performing an operation of separating crispy rice and rice.

3. The control method as claimed in claim 2, wherein after the first rice stewing process is completed and in response to a cover closing action detected by the cooking appliance, the second rice stewing process is continued to be executed;
or after the first rice stewing process is completed and the cooking appliance receives an instruction of continuing to make the claypot rice, the second rice stewing process is continued to be executed;
or after a predetermined time period from a time point of completing the first rice stewing process, the second rice stewing process is continued to be executed.

4. The control method as claimed in claim 1, wherein the control method comprises at least one of the following:
during the first rice stewing process, the heating component heating intermittently, so as to maintain the pot body in a first predetermined temperature range;
during the second rice stewing process, the heating component heating intermittently, so as to maintain the pot body in a second predetermined temperature range.

5. The control method as claimed in claim 4, wherein the control method comprises at least one of the following:
the first predetermined temperature range is 115° C. to 135° C.;
the second predetermined temperature range is 135° C. to 155° C.

6. The control method as claimed in claim 1, wherein
during the first rice stewing process, the heating component heats intermittently with a first heating duty cycle, or the heating component heats intermittently with a first power, or the heating component heats intermittently with a first heating duty cycle and a first power;
during the second rice stewing process, the heating component heats intermittently with a second heating duty cycle, or the heating component heats intermittently with a second power, or the heating component heats intermittently with a second heating duty cycle and a second power.

7. The control method as claimed in claim 6, wherein the control method comprises at least one of the following:
the first heating duty cycle is X₁:Y₁, wherein X₁ is 6 s to 16 s, Y₁ is 16 s to 26 s;
the second heating duty cycle is X₂:Y₂, wherein X₂ is 16 s to 26 s, Y₂ is 6 s to 16 s.

8. The control method as claimed in claim 1, wherein the control method comprises at least one of the following:
duration of the first rice stewing process is 10 min to 30 min;
duration of the second rice stewing process is 10 min to 30 min.

9. The control method as claimed in claim 1, wherein, before the rice stewing stage, the process of making the claypot rice further comprises a heating stage and a boiling stage;
the heating stage comprises a first heating stage and a second heating stage, which is executed after the first heating stage; in the first heating stage, the heating component heats the pot body continuously; in the second heating stage, the heating component heats intermittently with a third heating duty cycle; or,
in the boiling stage, the heating component heats intermittently with a fourth heating duty cycle, so that liquid in the raw materials placed in the cooking appliance maintains a boiling state; or
the heating stage comprises a second heating stage and a first heating stage executed before the second heating stage; in the first heating stage, the heating component heats the pot body continuously; in the second heating stage, the heating component heats intermittently with a third heating duty cycle, and in the boiling stage, the heating component heats intermittently with a fourth heating duty cycle, so that liquid in the raw materials placed in the cooking appliance maintains a boiling state.

10. The control method as claimed in claim 9, wherein when the cooking appliance starts the process of making the claypot rice, the control method comprises:
controlling the cooking appliance to directly switch the heating stage.

11. The control method as claimed in claim 9,
wherein the cooking appliance further comprises at least one of the following:
a pot body temperature sensor for reflecting a temperature of the pot body,
a content temperature sensor for reflecting a temperature of the raw materials placed in the pot body;
the cooking appliance switches among the stages according to the temperatures sensed by at least one of the pot body temperature sensor and the content temperature sensor, the stages comprises the first heating stage, the second heating stage, a boiling stage and the rice stewing stage.

12. The control method as claimed in claim 11, wherein in the heating stage, when the temperature of the pot body is greater than or equal to a first preset temperature, the control method further comprises: controlling the cooking appliance to switch from the first heating stage to the second heating stage; or,
when the temperature of the pot body is greater than or equal to a second preset temperature, and the temperature of the contents is greater than or equal to a third preset temperature, the control method further comprises: controlling the cooking appliance to switch from the second heating stage to the boiling stage; or,
when the temperature of the pot body is greater than or equal to a fourth preset temperature, the control method further comprises: controlling the cooking appliance to switch from the boiling stage to the rice strewing stage.

13. The control method as claimed in claim 12, wherein the control method further comprises at least one of the following:
the first preset temperature is 70° C. to 90° C.;
the second preset temperature is 80° C. to 100° C.;
the third preset temperature is 60° C. to 80° C.;
the fourth preset temperature is 100° C. to 120° C.

14. A cooking appliance, having a claypot rice mode; in the claypot rice mode, the cooking appliance is controlled to execute a control method as claimed in claim 1 for control.

15. The control method as claimed in claim 2, wherein the control method comprises at least one of the following:
during the first rice stewing process, the heating component heating intermittently, so as to maintain the pot body in a first predetermined temperature range;
during the second rice stewing process, the heating component heating intermittently, so as to maintain the pot body in a second predetermined temperature range.

16. The control method as claimed in claim 3, wherein the control method comprises at least one of the following:
during the first rice stewing process, the heating component heating intermittently, so as to maintain the pot body in a first predetermined temperature range;
during the second rice stewing process, the heating component heating intermittently, so as to maintain the pot body in a second predetermined temperature range.

17. The control method as claimed in claim 2, wherein
during the first rice stewing process, the heating component heats intermittently with a first heating duty cycle, or the heating component heats intermittently with a first power, or the heating component heats intermittently with a first heating duty cycle and a first power;
during the second rice stewing process, the heating component heats intermittently with a second heating duty cycle, or the heating component heats intermittently with a second power, or the heating component heats intermittently with a second heating duty cycle and a second power.

18. The control method as claimed in claim 3, wherein
during the first rice stewing process, the heating component heats intermittently with a first heating duty cycle, or the heating component heats intermittently with a first power, or the heating component heats intermittently with a first heating duty cycle and a first power;
during the second rice stewing process, the heating component heats intermittently with a second heating duty cycle, or the heating component heats intermittently with a second power, or the heating component heats intermittently with a second heating duty cycle and a second power.

19. The control method as claimed in claim 2, wherein the control method comprises at least one of the following:
duration of the first rice stewing process is 10 min to 30 min;
duration of the second rice stewing process is 10 min to 30 min.

20. The control method as claimed in claim 3, wherein the control method comprises at least one of the following:
duration of the first rice stewing process is 10 min to 30 min;
duration of the second rice stewing process is 10 min to 30 min.
